(19) United States
(12) Patent Application Publication
(10) Pub. No.: US 2011/0173854 A1
(43) Pub. Date: Jul. 21, 2011

(54) SIGN SASH

(76) Inventor: Max Pappas, Washington, DC (US)

(21) Appl. No.: 13/011,778

(22) Filed: Jan. 21, 2011

Related U.S. Application Data
(60) Provisional application No. 61/297,276, filed on Jan. 21, 2010.

(51) Int. Cl. G09F 15/00; B41K 5/00

(52) U.S. Cl. 40/606.19; 101/90

(57) ABSTRACT

A sign sash is placed around a corner of an existing political campaign or other sign and conveys an additional message. A strip of paper is scored down the middle and folded over to form front and back sign sash portions. The front and back portions are connected at their edges and at least one bears a display. A sign corner can be inserted between the front and back portions and the sign sash allowed to rest on the sign and display the graphic across the surface of the sign. The sign sash is made of rigid card-stock and adhesive and/or fasteners connect the front and back portions. A fastener can secure the sheet to the sign corner or another object. The sign sash is useful for varying sign messages and for adding to the message as events change, for instance to thank supporters after a vote is concluded.

This application claims the benefit of U.S. Ser. No. 61/297,276, filed Jan. 21, 2010, which is hereby incorporated by reference in its entirety.

### BACKGROUND

The present invention relates generally to signs. Signs have been used ubiquitously for centuries to carry advertisements and notices. For many years, yard signs that are secured to the ground have been popular in political campaigns. These temporary yard signs are put up by campaign volunteers or workers during a campaign, typically in busy public places such as road medians or on private property, and later taken down after the campaigns are over. They are good for building name recognition for candidates, spreading awareness of campaign messages, and for reminding supporters of election dates. These types of signs must be inexpensive and easy to transport, set up, and take down. Typically the signs are constructed of printed card-stock, corrugated plastic, or poly-bag, a cheap trashbag-like plastic that is placed over a u-wicket embedded in the ground.

It is very difficult and time-consuming to change or add to the message borne by such signs. Putting out new signs to send a slightly different message or short additional message as a campaign progresses is expensive and laborious. Sign riders allow one corrugated sign to be placed on top of another using metal pins inserted into holes in the top and bottom of the respective corrugated signs, but do not work with other types of signs and are cumbersome and expensive. Needs exist for improved methods and devices for altering or adding to the appearance of signs.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In certain embodiments, the disclosed embodiments may include one or more of the features described herein.

A new sign sash for political campaign signs, as well as other sign applications, is added around a corner of an existing sign in order to convey an additional message beyond that on the sign itself. The sign sash is typically placed diagonally across the corner of a sign such as a political yard sign, much like sashes are worn by contestants in beauty pageants (but in many embodiments the sign sash is of rigid construction). Rather than displaying the name of a state, as a beauty pageant sash often does, these sign sashes in some embodiments convey additional information to the viewer of the sign. In the case of a political yard sign, a candidate could use the sash to reference his or her primary issues: “Jobs Jobs Jobs!”, “Lower Taxes”, “Better Schools”, “Fix Health Care”, etc or other messages like “Vote Today!”, “Thank You”, etc.

The sign sash is useful for varying sign messages inexpensively by using varying sashes, for altering the message between different geographic areas, and for adding to the message as events change, for instance to reminder supporters that a vote is upcoming, or to thank supporters after a vote is concluded. Changing a sign's message makes passerby notice it more, and this sash allows for the message to be changed quickly and inexpensively. In 2008, $2.6 billion was spent on advertising for political campaigns for offices ranging from dog catcher to President of the United States. Sign sashes are a form of advertisement, including for politicians. Campaign signs are big business, with sales in the tens of millions of dollars in election years. For one state representative race representing 30,000 people, one candidate typically spends around $2,500 for 500 signs. Many districts will have 2 candidates running for the same office, as well as other candidates running for local office and state wide and federal offices with less sign density. 1,500 signs, or $7,500 worth, would be typical in an area of 30,000 in an election year, amounting to about $75 million spent on such signs for the entire country of over 300 million people.

Sign sashes reduce candidates' costs while increasing the effectiveness of their advertising campaign. Not all who purchase yard signs will also purchase sashes, but others who use similar signs also will find uses for it. Therefore, the market for sign sashes is in the tens of millions of dollars.

A new sign sash includes a sheet having connected front and back portions, a display on at least one of the front and back portions, and a middle area of the sheet where the front and back portions are not connected. A sign corner or other object can be inserted between the front and back portions in the middle area and the sheet allowed to rest on the sign corner or other object, laying the display over the surface of the sign corner or other object. In one embodiment, the sheet is a sheet of rigid card-stock and an adhesive connecting the front and back portions. In one embodiment, a fastener secures the sheet to the sign corner or other object. In one embodiment, the front and back portions are connected only at their side edges. In one embodiment, the display comprises at least one of the group consisting of printed words, designs, graphics, three-dimensional objects, and lights. In one embodiment, a side edge of the sheet is angled such that it can be arranged parallel with the sign side it rests against when a sign corner is inserted between the front and back portions in the middle area. In one embodiment, there are displays on both the front and the back portions and the displays differ. In one embodiment, a fastener connects the front and back portions.

In a new sign sash method, the corner of a sign is inserted between the front and back portions of the sign sash in the middle area and the sign sash is released and allowed to rest on the sign corner and lay its display over the surface of the sign. In one embodiment, the angle of the sign sash is adjusted to achieve a desired angle for the display. In one embodiment, the sign sash display includes a message that is complementary to a message on the sign. In one embodiment, the sign is a political candidate sign and the sign sash message relates to a political issue of importance to the candidate, reminds viewers to vote, or thanks supporters. In one embodiment, the steps of inserting and releasing are repeated for a plurality of signs and sign sashes and the messages on the plurality of sign sashes vary. In one embodiment, the messages vary on the basis of sign location or date of sign sash application.

In a new sign sash manufacturing method, displays are printed on a sheet of paper or similar product, the sheet of paper is cut into strips, each strip having one or two of the displays, and two ends of a single strip or of two separate strips are fastened together. In one embodiment, one strip having two displays is folded in half, such that the folded strip has one display on each half of its outward-facing side, and two free ends of the folded strip are fastened together. In one embodiment, two ends of two separate strips are fastened together and two other ends of the two separate strips are fastened together such that each strip bears its display on its outward-facing side. In one embodiment, an adhesive or a mechanical fastener is applied to carry out the fastening.

A new sign sash system includes a sign having a sign corner and a sign sash, and the sign corner is inserted between the front and back portions of the sign sash in the middle area and the sheet rests on the sign corner and lays the display across the surface of the sign. In one embodiment, the sign sash is a sticker that wraps around from one side of the sign to the other and has displays on the front and back portions.

These and other objectives and features of the invention are apparent in the disclosure, which includes the above and ongoing written specification.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art.

FIG. 1 is a diagram illustrating a method of constructing sign sashes.

FIG. 2 is a diagram of a sign sash.

FIG. 3 is a diagram showing a sign sash mounted on a lawn sign.

FIG. 4 is a diagram showing two methods of assembling a sign sash.

FIG. 5 is a diagram of a sign sash with a trapezoidal surface.

FIG. 6 is a diagram of a sign sash with a trapezoidal surface and various surface displays.

FIG. 7 is a diagram illustrating a sign sash application process.

FIG. 8 is a diagram of a sign sash sticker applied to a lawn sign.

### DETAILED DESCRIPTION

A sign sash will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The figures are not to scale. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

The sash in one embodiment is made of a folded and glued, stapled, or otherwise fastened cardstock for rigidity, giving the sash the strength to resist being damaged or blown away in adverse weather including rain, wind, etc. In one such embodiment, the sash is two stiff strips of cardstock glued together at their ends, allowing it to be placed over the corner of a sign so that it extends diagonally across the sign. In other embodiments, the sign sash may be made of any material, for example plastic, so long as the material has the necessary properties for the intended use of the sign sash. Various angles of extension across the sign are possible. A different message can be printed on each side of the sash. The sash naturally resists being blown away, being made of relatively heavy and rigid card-stock and fitted closely to the sign it is mounted on. However, a metal, plastic, or other fastener can be used for additional security if bad weather is anticipated. The sash can be used with any type of sign, including cardstock, corrugated plastic, or poly-bag (trashbag-like plastic placed over u-wickets).

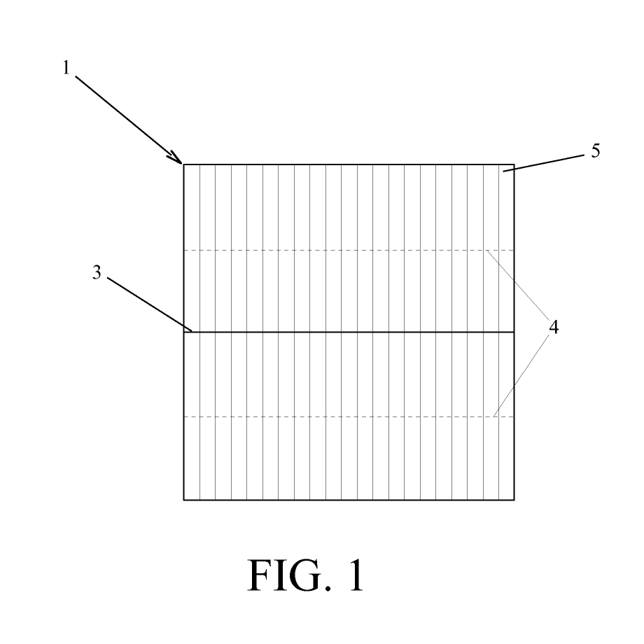

Like many campaign signs, in one embodiment the sign sashes are made of silk screened, folded paper. A sheet of paper is printed and cut into strips, two of which are fastened together at their edges with glue to create a double-sided sign sash. FIG. 1 shows a sheet of paper/card-stock 1 that has been printed with a repeating message. To create sign sashes with different messages and/or double-sided sign sashes with different messages on each side, instead of printing one repeated message, varying messages can be printed on the paper/card-stock sheet 1. The paper 1 is then cut into strips 5, such that each strip contains the printed message. The strips 5 are scored down the middle 4 for easy folding. The paper 1 may be long enough for multiple strips 5 to be printed in a row, in which case a cut 3 can be made horizontally to separate one set of strips 5 from the next.

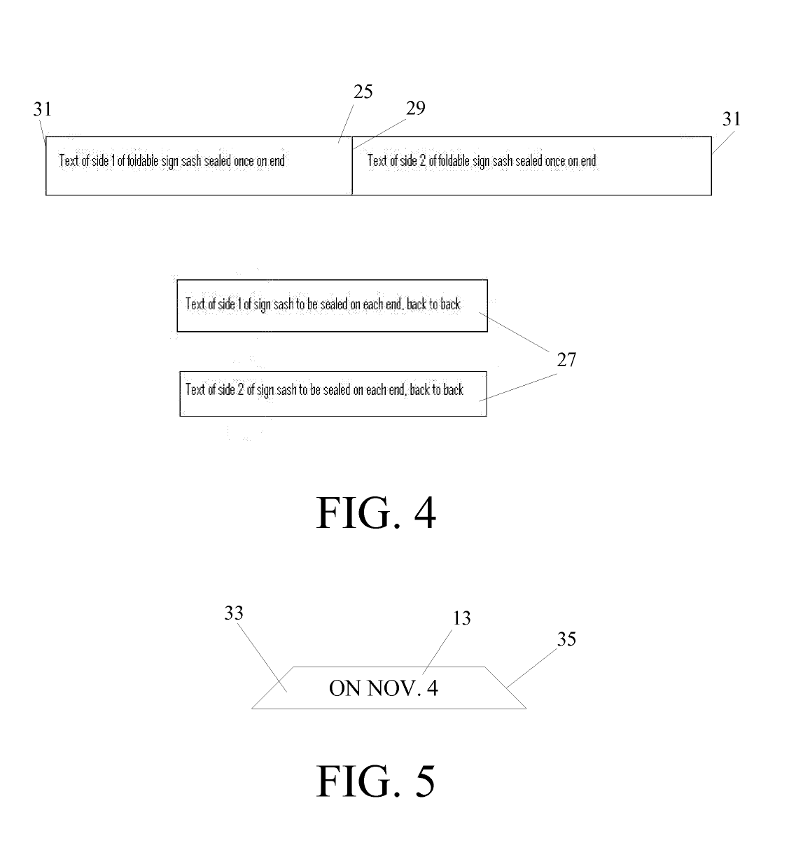

Alternatively, a horizontal cut 3 can be made only after the message is repeated twice, resulting in strips 5 having a repeated message. Such strips 25 are shown in FIG. 4. The strips can then be folded in half at their midpoint 29 (where the strips may be scored for easy folding) to form a double-sided sign sash, requiring adhesive or another fastener to be applied only at the free ends 31 forming one side end of the resulting side sash. In contrast, with separate sheets 27 placed back-to-back to form a sign sash, adhesive or another fastener must be applied at both sides of the resulting sign sash.

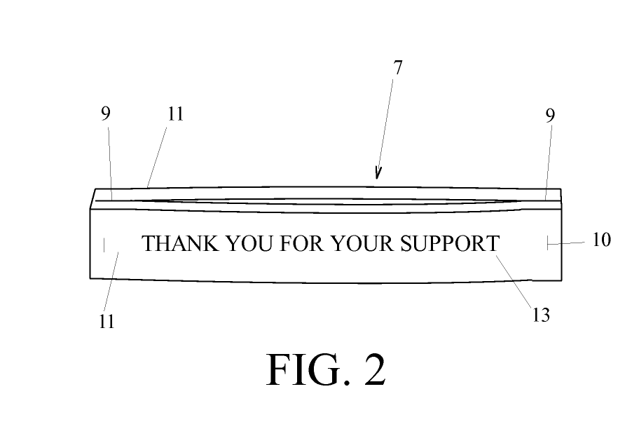

FIG. 2 is a diagram of a completed sign sash 7. Two strips 11 with messages 13 have been placed back-to-back and attached with adhesive 9 at their edges. Fasteners such as staples 10 can be used instead of or in addition to adhesive. If the sign sash is made by folding over a single long strip instead of placing two separate strips back-to-back, an adhesive or fastener is not necessary at one of the edges of the sash. In this figure the sash 7 is flexed slightly to show that the two sides 11 are not attached in the middle and can part to fit around a sign corner.

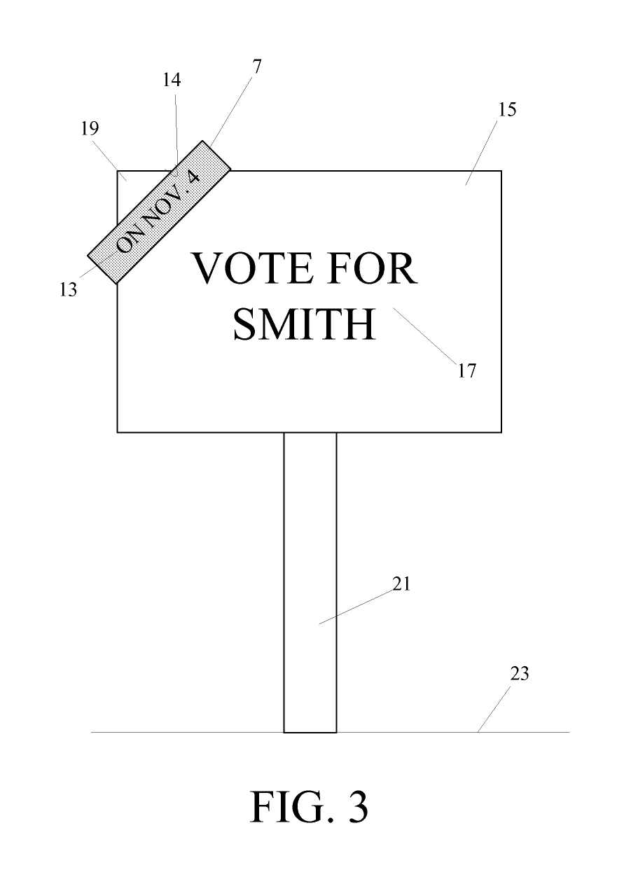

FIG. 3 is a diagram showing a sign sash 7 mounted on a lawn sign 15 with a lawn sign message 17 and sign stand 21 inserted into the ground 23. The sign sash 7 with sash message 13 has been slipped over the upper-left corner 19 of the lawn sign 15. The edge of the lawn sign 15 fits snugly into the inside edges of the sign sash 7 where the gap between the two sides of the sash created by insertion of the lawn sign 15 narrows, securing the sign sash 7 to the lawn sign 15. One or more fasteners 14 may also be used to secure the sash. The fastener may be a standard paper or binder clip, pin, or any other type of known fastener.

In an alternative embodiment shown in FIG. 4, the sides 35 of the sign sash 33 are angled, rather than straight, creating a trapezoidal surface. When placed on a sign, the ends 35 of this sign sash 33 will be fairly flush with the sides of the sign on which it rests, depending on the angle at which it extends. For example, for a sign sash 33 with sides 35 at 45° angles, the sides 35 will be flush with the sign sides when the sign sash extends at a 45° angle across the surface of the sign. By increasing the surface area of the sign sash that is in contact with the sign, friction force is increased, helping to resist wind and other dislodging forces. However, a sign sash of this type is somewhat more difficult to manufacture.

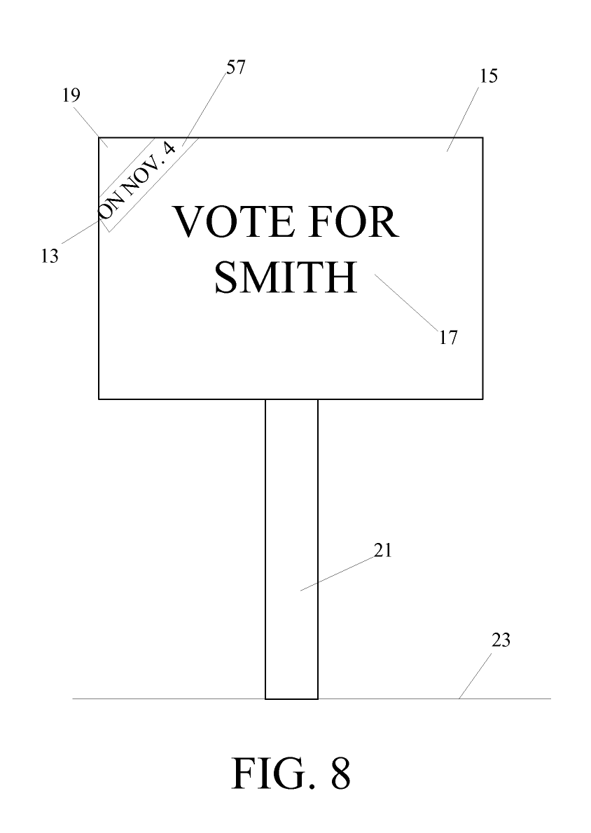

In an alternative embodiment, the sign sash is a sticker. In this embodiment, the sign sash can be applied separately to each side of a sign (or to only one side), or a single long sign sash sticker can be used to wrap around from one side of the sign to the other. FIG. 8 shows a sign sash sticker 57 applied to a lawn sign. The advantage of a sticker is that it is secured to the sign with an adhesive, decreasing the chances that it will be blown away or otherwise dislodged. On the other hand, stickers are typically made of a thin material that may be more vulnerable to wear. The main downside of a sticker is that it is often difficult to remove a sticker from a sign without leaving residue and tearing the sign. Political candidates frequently reuse campaign signs in subsequent elections to save on costs, and for that reason it is undesirable to leave residue on such a sign. Sticker application is also somewhat time-consuming.

FIG. 7 illustrates a sign sash application process. First, the geographic location of a sign is considered 43 and the date of sign sash application is considered 45 and a sign sash with a certain message is selected 47. A sign corner is inserted into the sign sash 49 and the sign is released 51 and allowed to rest on the sign and lay its display across the surface of the sign. The sign sash angle is then adjusted 53 as appropriate. If there are more signs that need to have sign sashes applied, the process begins again with consideration of sign location and date 43, 45. Otherwise, sign sash application is complete 55.

Sign sashes are very useful for candidates for public office. The sign sash enables them to get much more value out of their yard signs, which almost all candidates use. Laws about where signs can be placed vary from state to state, with some allowing placement on public property and some only on private property. In states where a sign can only be placed in private property, and not in public property, the biggest challenge is finding people to put your signs on their property. When signs can be placed on public property, a few volunteers can go out and place as many signs as necessary whenever prudent. When only private property can be used, it is more difficult to get a number of signs placed. Getting additional signs placed or making changes to an existing sign are very difficult. The sign sash makes it easier and less expensive to add or change a sign's message and therefore greatly increases the chances of successfully making such changes in states where signs can be placed only on private property.

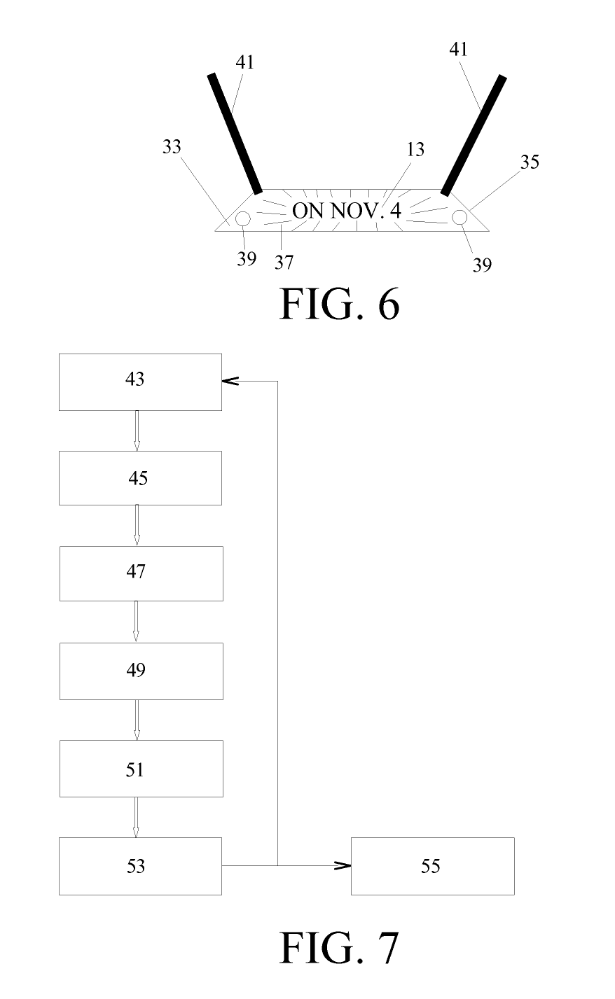

The sign sash can have any type of display on its surface, not only political or other messages. The display can include printed words, designs, and graphics, three-dimensional objects, lights, etc. FIG. 6 shows a sign sash having various displays including a graphic 37, lights 39, and three-dimensional objects 41, here streamers. Such non-text displays are especially useful in commercial applications.

The invention is not limited to the particular embodiments described above in detail. Those skilled in the art will recognize that other arrangements could be devised, for example, various ways of joining the two sides of the sign sash, varied methods for printing and constructing the sign sashes, varied types of fasteners, etc. While the invention has been described with reference to specific illustrative embodiments, modifications and variations of the invention may be constructed without departing from the scope of the invention.

I claim:

1. A sign sash, comprising:
a sheet comprising connected front and back portions;
a display on at least one of the front and back portions; and
a middle area of the sheet where the front and back portions are not connected;
wherein a sign corner or other object can be inserted between the front and back portions in the middle area and the sheet allowed to rest on the sign corner or other object, laying the display over the surface of the sign corner or other object.

2. The sign sash of claim 1, wherein the sheet is a sheet of rigid card-stock, further comprising an adhesive connecting the front and back portions.

3. The sign sash of claim 1, further comprising a fastener for securing the sheet to the sign corner or other object.

4. The sign sash of claim 1, wherein the front and back portions are connected only at their side edges.

5. The sign sash of claim 1, wherein the display comprises at least one of the group consisting of printed words, designs, graphics, three-dimensional objects, and lights.

6. The sign sash of claim 1, wherein a side edge of the sheet is angled such that it can be arranged parallel with the sign side it rests against when a sign corner is inserted between the front and back portions in the middle area.

7. The sign sash of claim 1, wherein there are displays on both the front and the back portions and wherein the displays differ.

8. The sign sash of claim 1, further comprising a fastener connecting the front and back portions.

9. A sign sash method, comprising:
inserting the corner of a sign between the front and back portions of the sign sash of claim 1 in the middle area; and
releasing the sign sash and allowing it to rest on the sign corner and lay its display over the surface of the sign.

10. The sign sash method of claim 9, further comprising adjusting the angle of the sign sash to achieve a desired angle for the display.

11. The sign sash method of claim 9, wherein the sign sash display comprises a message that is complementary to a message on the sign.

12. The sign sash method of claim 11, wherein the sign is a political candidate sign and the sign sash message relates to a political issue of importance to the candidate, reminds viewers to vote, or thanks supporters.

13. The sign sash method of claim 11, further comprising repeating the steps of inserting and releasing for a plurality of signs and sign sashes, wherein the messages on the plurality of sign sashes vary.

14. The sign sash method of claim 13, wherein the messages vary on the basis of sign location or date of sign sash application.

15. A sign sash manufacturing method, comprising:
printing displays on a sheet of paper;
cutting the sheet of paper into strips, each strip having one or two of the displays; and
fastening together two ends of a single strip or of two separate strips.

16. The sign sash manufacturing method of claim 15, further comprising folding one strip having two displays in half, such that the folded strip has one display on each half of its outward-facing side, wherein the fastening together two ends of a single strip or of two separate strips comprises fastening together two free ends of the folded strip.

17. The sign sash manufacturing method of claim 16, further comprising scoring the one strip down the middle for ease of folding.

18. The sign sash manufacturing method of claim 15, wherein the fastening together two ends of a single strip or of two separate strips comprises fastening together two ends of two separate strips, further comprising fastening together two other ends of the two separate strips such that each strip bears its display on its outward-facing side.

19. The sign sash manufacturing method of claim 15, wherein the fastening comprises application of adhesive or a mechanical fastener.

20. A sign sash system, comprising:
a sign comprising a sign corner; and
the sign sash of claim 1;
wherein the sign corner is inserted between the front and back portions in the middle area and the sheet rests on the sign corner and lays the display across the surface of the sign.

21. The sign sash system of claim 19, wherein the sign sash is a sticker that wraps around from one side of the sign to the other and has displays on the front and back portions that complement a message on the sign.
